(19) United States
(12) Patent Application Publication
(10) Pub. No.: US 2017/0227168 A1
(43) Pub. Date: Aug. 10, 2017

(54) One-Piece Circuit Board-Based LED Lamp Bulb

(71) Applicant: Tse Min Chen, Hsinchu (TW)

(72) Inventor: Tse Min Chen, Hsinchu (TW)

(21) Appl. No.: 15/016,391

(22) Filed: Feb. 5, 2016

(51) Int. Cl. F21K 9/235; F21K 9/232

(52) U.S. Cl. CPC F21K 9/235; F21K 9/232

(57) ABSTRACT

A LED lamp bulb includes a lamp base, a bulb mounted at the top side of the lamp base, and a circuit board electrically connected to the lamp base and surrounded by the bulb. The circuit board is a one-piece circuit board vertically inserted into the lamp base and thus electrically connected with the lamp base, having one or a number of LEDs mounted at each of opposing first and second sides thereof near the top. The horizontal centerline of each LED at each of the first and second sides of the circuit board defines with the horizontal direction of the first or second side of the circuit board a contained angle within 25°˜45°. Further, the topmost edge of the circuit board is disposed above the elevation of the topmost edge of the lamp base.

### BACKGROUND OF THE INVENTION

1. Field of the Invention

The present invention relates to lamps and more particularly, to a LED lamp bulb, which comprises a lamp base, a circuit board vertically inserted into the lamp base to achieve electric conduction with the lamp base and a bulb mounted at the top side of the lamp base over the circuit board, wherein the horizontal centerline of each LED at each of opposing first and second sides of the circuit board defines with the horizontal line of the respective first or second side of the circuit board a predetermined contained angle, so that the LED lamp bulb is capable of emitting light uniformly in all directions.

2. Description of the Related Art

Various LED lamp designs are known. Exemplars are seen in US 2006/0215422; 2010/0253221; 2003/0185020; 2011/0050124; 2011/0298371. Among these prior art designs, the LED light bulb disclosed in US 2006/0215422 discloses is based on one single piece of circuit board, however, this design is not practical for Christmas lamp application. Because the LED light bulb is disposed in an upward position, it cannot emit light evenly in different directions. For providing light in different directions, multiple LED light bulbs must be installed, however, because a major part the large circuit board is disposed inside the bulb, a large area of shadow will be produced.

In a conventional LED lamp bulb (see FIG. 1 and FIG. 2), in the consideration of optical factors, LEDs (light-emitting diodes) 6 must be disposed in an upward position. According to this prior art design, LEDs 6 are mounted in the top side of a first circuit board 81 that is electrically connected to a top side of a second circuit board 82 that is vertically mounted in a lamp base 7. Because related electronic components, such as bridge rectifier 91, AC step-down high voltage capacitor 92, resistor 93, LED current-limit resistor 94 require much installation space, they cannot be mounted with the LEDs 6 in the top side of the first circuit board 81. Because this prior art design needs to install one first circuit board 81 and one second circuit board 82, an additional soldering process is needed to electrically connect the first circuit board 81 to the second circuit board 82, complicating the installation and also relatively increasing the defect rate.

### SUMMARY OF THE INVENTION

The present invention has been accomplished under the circumstances in view. It is therefore the main object of the present invention to provide a LED lamp bulb, which comprises a lamp base, a bulb mounted at the top side of the lamp base, and a circuit board electrically connected to the lamp base and surrounded by the bulb, wherein the horizontal centerline of each LED at each of the opposing first and second sides of the circuit board defines with the horizontal direction of the respective first or second side of the circuit board a contained angle within 25°˜45°. Thus, the LED lamp bulb is capable of emitting light uniformly in all directions, and the amount of LEDs can be minimized.

It is another object of the present invention to provide a LED lamp bulb, which comprises a lamp base, a bulb mounted at the top side of the lamp base, and a circuit board electrically connected to the lamp base and surrounded by the bulb, wherein the circuit board is a one-piece member vertically inserted into the lamp base to achieve electric conduction with the circuit board; the topmost edge of the circuit board is above the elevation of the topmost edge of the lamp base, preventing generation of a large area of shadow caused by the circuit board when the LEDs at the circuit board are turned on to give off light.

It is still another object of the present invention to provide a LED lamp bulb, which comprises a lamp base, a bulb mounted at the top side of the lamp base, and a circuit board electrically connected to the lamp base and surrounded by the bulb, wherein the circuit board is a one-piece member directly and vertically inserted into the lamp base to achieve electric conduction with the circuit board, thus, the invention greatly saves the installation labor and time. Further, because no any further soldering process is necessary, the invention greatly increases the yield and improves the product quality.

It is still another object of the present invention to provide a LED lamp bulb, is practical for customized production. In production, the angles of the LEDs can be designed according to clients' requirements, for example, a low LED angle can enhance the brightness of the upper segment; a large LED angle LED can increase the angular range of luminance on both sides, covering a relatively large angle.

### BRIEF DESCRIPTION OF THE DRAWING

FIG. 1 is an exploded view of a LED lamp bulb according to the prior art.

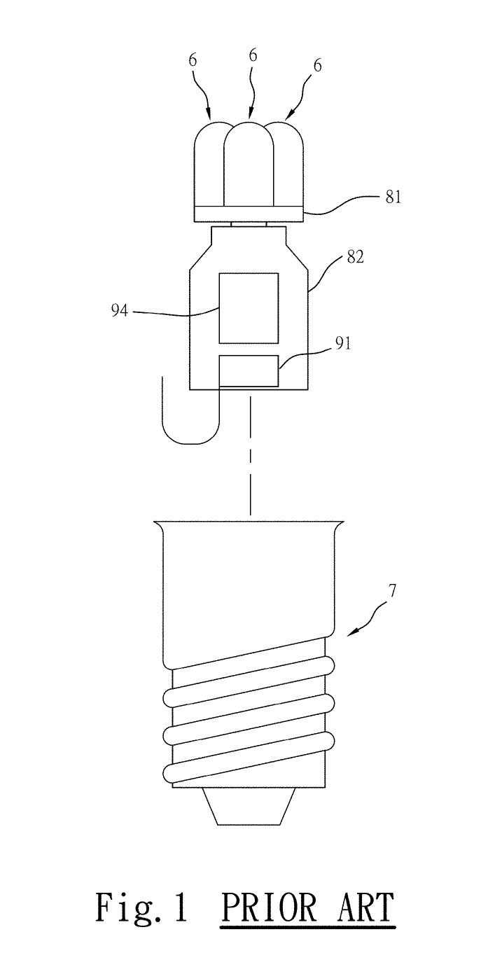

FIG. 2 is a side plain view of a part of the prior art LED lamp bulb.

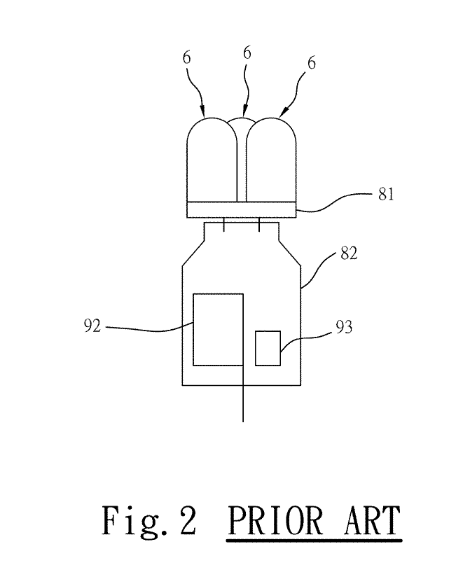

FIG. 3 is an exploded view of a LED lamp bulb in accordance with the present invention (the bulb excluded).

FIG. 4 is a side plain view of the circuit board of the LED lamp bulb in accordance with the present invention.

FIG. 5 is an assembly view of the circuit board and lamp base of the LED lamp bulb in accordance with the present invention.

FIG. 6 is a front plain view of the LED lamp bulb in accordance with the present invention.

### DETAILED DESCRIPTION OF THE INVENTION

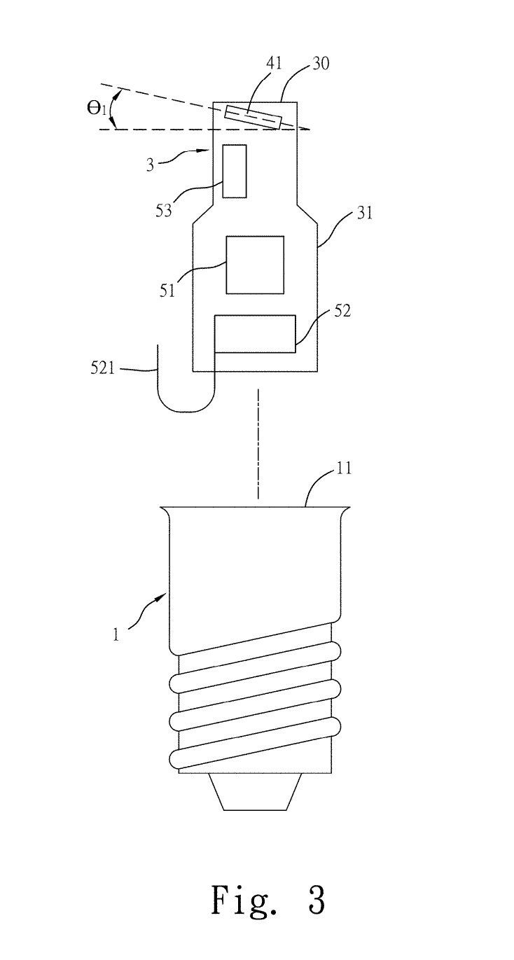

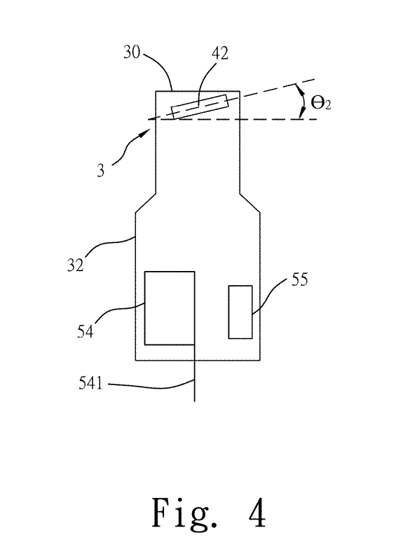

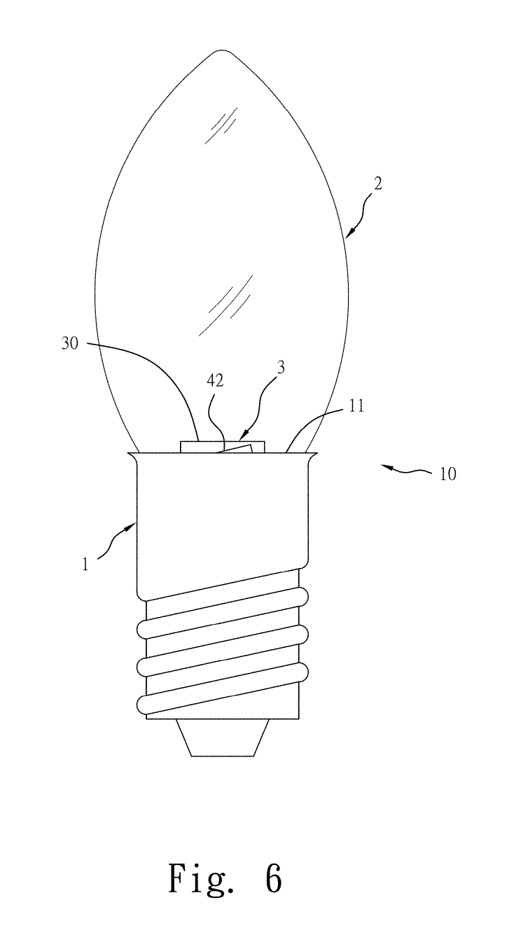

Referring to FIGS. 3-6, a LED lamp bulb 10 in accordance with a first embodiment of the present invention is shown. The LED lamp bulb 10 comprises a lamp base 1, a bulb 2 mounted at a top side of the lamp base 1 (see FIG. 6), and a circuit board 3 electrically connected to the lamp base 1 and surrounded by the bulb 2. The circuit board 3 has at least one LED (light-emitting diode) 41, a bridge rectifier 51, a first resistor 52 and a LED current-limit resistor 53 installed in a first side 31 thereof (see FIG. 3), and at least one LED 42, an AC step-down high voltage capacitor 54 and a second resistor 55 installed in an opposite second side 32 thereof (see FIG. 4). The first resistor 52 has the negative terminal 521 thereof electrically connected to the lamp base 1 to form a positive contact. The AC step-down high voltage capacitor 54 has the positive terminal 541 thereof electrically connected to the lamp base 1.

The LED lamp bulb 10 of the present invention is characterized in that:

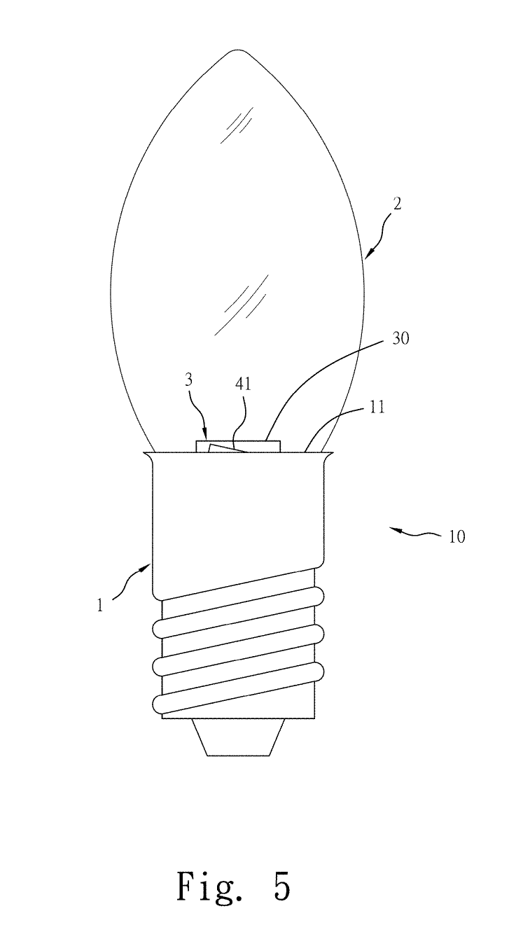

The LED 41 at the first side 31 of the circuit board 3 is disposed near a top end of the first side 31; the horizontal centerline of the LED 41 defines with the horizontal direction of the first side 31 a contained angle θ₁ within 25°˜45° (see FIG. 3). The LED 42 at the second side 32 of the circuit board 3 is disposed near a top end of the second side 32; the horizontal centerline of the LED 42 defines with the horizontal direction of the second side 32 a contained angle θ₂ within 25°˜45° (see FIG. 4). Thus, the LED lamp bulb 10 is capable of emitting light uniformly in all directions (see FIG. 5 and FIG. 6). When the LED lamp bulb 10 is used for making a Christmas lamp, the amount of LEDs can be minimized, and the Christmas lamp thus made can be positioned in any desired angle to provide light uniformly in all directions. Further, the circuit board 3 is a one-piece member. In installation, the circuit board 3 is vertically inserted into the lamp base 1 to achieve electric conduction with the lamp base 1. After installation, the topmost edge 30 of the circuit board 3 is disposed above the elevation of the topmost edge 11 of the lamp base 1 (see FIG. 5 and FIG. 6), preventing generation of a large area of shadow caused by the circuit board 3 when the LEDs 41,42 are turned on to give off light. Further, because the circuit board 3 is a one-piece member directly and vertically inserted into the lamp base 1 and electrically connected thereto, the invention greatly saves the installation labor and time. Further, because no any further soldering process is necessary, the invention greatly increases the yield and improves the product quality.

Further, the at least one LED 41 at the first side 31 of the circuit board 3 or the at least one LED 42 at the second side 32 of the circuit board 3 can be respectively comprised of at least one side-emitting LED.

In conclusion, the invention provides a LED lamp bulb 10 that has the features and advantages as follows:

1. The horizontal centerline of the LED 41 defines with the horizontal direction of the first side 31 of the circuit board 3 a contained angle θ₁ within 25°˜45°. The horizontal centerline of the LED 42 defines with the horizontal direction of the second side 32 of the circuit board 3 a contained angle θ₂ within 25°˜45°. Thus, the LED lamp bulb 10 is capable of emitting light uniformly in all directions, and the amount of LEDs can be minimized.

2. The circuit board 3 is a one-piece member vertically inserted into the lamp base 1 to achieve electric conduction with the circuit board 3. Further, the topmost edge 30 of the circuit board 3 is above the elevation of the topmost edge 11 of the lamp base 1, preventing generation of a large area of shadow caused by the circuit board 3 when the LEDs 41,42 are turned on to give off light.

3. Because the circuit board 3 is a one-piece member directly and vertically inserted into the lamp base 1 to achieve electric conduction with the circuit board 3, the invention greatly saves the installation labor and time. Further, because no any further soldering process is necessary, the invention greatly increases the yield and improves the product quality.

4. The LED lamp bulb 10 is practical for customized production. In production, the angles of the LEDs can be designed according to clients' requirements, for example, a low LED angle can enhance the brightness of the upper segment; a large LED angle LED can increase the angular range of luminance on both sides, covering a relatively large angle.

What is claimed is:

1. A LED lamp bulb comprising a lamp base, a bulb mounted at a top side of said lamp base, and a circuit board electrically connected to said lamp base and surrounded by said bulb, said circuit board comprising opposing first side and second side, at least one light-emitting diode mounted at each of said first side and said second side of said circuit board, wherein:
the at least one said light-emitting diode at said first side of said circuit board is disposed near a top end of said first side, and the horizontal centerline of each said light-emitting diode at said first side of said circuit board defines with the horizontal direction of said first side a contained angle within 25°˜45°; the at least one said light-emitting diode at said second side of said circuit board is disposed near a top end of said second side, and the horizontal centerline of each said light-emitting diode at said second side of said circuit board defines with the horizontal direction of said second side of said circuit board a contained angle within 25°˜45°; said circuit board is a one-piece member vertically inserted into said lamp base to achieve electrical conduction with said lamp base; the topmost edge of said circuit board is disposed above the elevation of the topmost edge of said lamp base.

2. The LED lamp bulb as claimed in claim 1, wherein the at least one said light-emitting diode at said first side of said circuit board and the at least one said light-emitting diode at said second side of said circuit board each comprise at least one side-emitting light-emitting diode.
